(19) United States
(12) Patent Application Publication
(10) Pub. No.: US 2018/0206413 A1
(43) Pub. Date: Jul. 26, 2018

(54) Wall component and track system for forming a wall for growing plants.

(71) Applicant: BIOTECTURE LTD, West Sussex (GB)

(72) Inventor: Richard SABIN, West Sussex (GB)

(21) Appl. No.: 15/559,144

(22) PCT Filed: Mar. 18, 2016
(86) PCT No.: PCT/GB2016/000053

§ 371 Date: Sep. 18, 2017

(30) Foreign Application Priority Data
Mar. 19, 2015 (GB) 1504620.4
Nov. 23, 2015 (GB) 1520680.8

(51) Int. Cl. A01G 9/02

(52) U.S. Cl. CPC A01G 9/025

(57) ABSTRACT

The invention relates to a wall component and track system (1). System (1) has a plurality of tracks (10) for secured horizontally against a wall (2) at spaced intervals, and a plurality of wall components (20) adapted to be placed between adjacent tracks, each component having upper and lower engagement members (23A,23B) and (22A,22B,22C,22D) to releasably engage with a track above and below a component. The components each having a front face (21) A with apertures X to receive plants. The invention also relates to a wall system with at least one cover plate for placement between rows of wall components to hide the irriga tion pipes and the space between rows of components.

The present invention relates to a wall component and track system for forming a wall for growing plants.

It is well known to secure a matrix of wall components to a wall using fixings such as screws to secure each component to a wall. The components are usually arranged in rows and columns, with vertical spacing between rows of components along which irrigation pipes can be fed. Such an arrangement is disclosed in our GB2475101.

A problem with such known arrangements is that each wall components need to be screwed to a wall which is time consuming and costly if scaffolding needs to be erected. Also if it is desired to remove one or more wall components to replace plants or replace irrigation pipes, screws are not easily unscrewed. Usually the irrigation system is a permanent installation and not easily removed between components.

The invention seeks to provide a system which avoids the disadvantages of known walls for growing plants.

It is also well known to secure a matrix of wall components to a wall using fixings to secure each component to a wall. The components are usually arranged in rows and columns, with vertical spacing between rows of components along which irrigation pipes can be fed. A problem with such known arrangements is that the vertical spacing between rows allows the pipes to be seen which is unsightly. The invention also seeks to provide a system which avoids the pipes being visible.

According to a first aspect of the present invention there is provided a wall component and track system comprising:

a) a plurality of tracks for secured horizontally against a wall at spaced intervals,

b) a plurality of wall components adapted to be placed between adjacent tracks, each component having upper and lower engagement members to releasably engage with a track above and below a component, said components each having a front face with apertures to receive plants.

Preferably the upper and lower engagement members include lugs and rotatable fingers which engage with the tracks. 3. Preferably the lugs and fingers project adjacent a back face of each wall component. Preferably the rotatable fingers can be rotated from the front face of a component.

Preferably the track is T-shaped with a stalk for securement to a wall and arms to be spaced form the wall by the stalk. Preferably the fingers and lugs on a wall component engage between the wall and track arms.

Preferably the arms form a U-shaped channel to take pipe supports. Preferably the pipe supports are clips. The clips may have lugs which engage with the U-shaped channel when clip twisted.

According to a second aspect of the present invention there is provided a wall component and track system comprising:

a) a plurality of tracks for secured horizontally against a wall at spaced intervals,

b) a plurality of wall components adapted to be placed between adjacent tracks, and

c) securement means releasably connectable to the track to secure irrigation pipes to the tracks.

The second aspect of the invention may have features of the first aspect of the invention mentioned above.

According to a third aspect of the present invention there is provided a wall component system forming a wall for growing plants comprising:

a) a plurality of wall components arranged in rows and columns with vertical spacing between rows of components,

b) irrigation pipes in the space between rows of components to irrigate the wall components, and

c) at least one cover plate for placement between rows of wall components to hide the irrigation pipes and the space between rows of components.

Preferably the or each cover plate has a front and rear face, and the rear face supports one or more engagement means to engage over an irrigation pipe to secure the or each cover plate between rows of wall components. Preferably the or each engagement means is a clip. Preferably the or each clip is positionable at different locations on the rear face.

Preferably the rear face forms a C-shaped channel to take clips. The clips may have lugs which releasably engage with the C-shaped channel when clip twisted.

An embodiment of the invention will now be described with reference to the accompanying drawings in which:

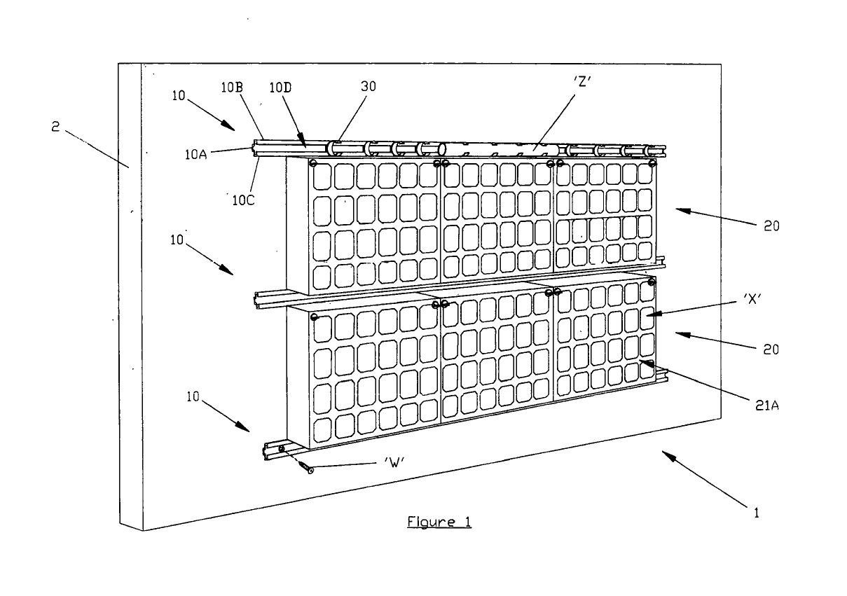

FIG. 1 shows a plurality of wall components supported by tracks and forming part of a wall for plants,

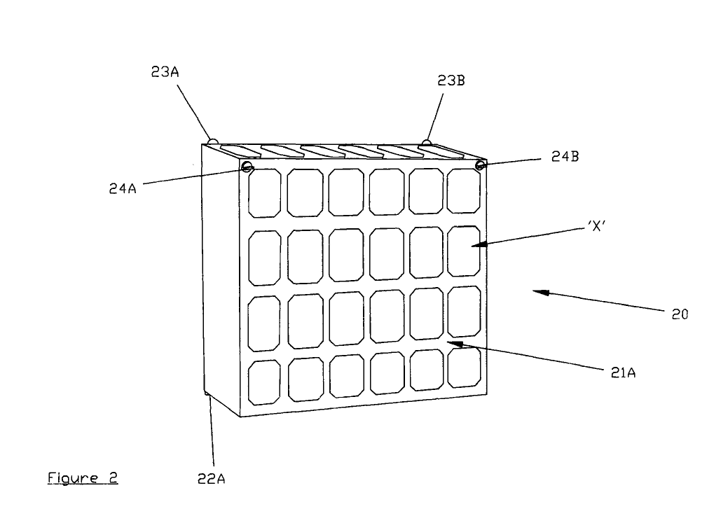

FIG. 2 shows a front view of a wall component,

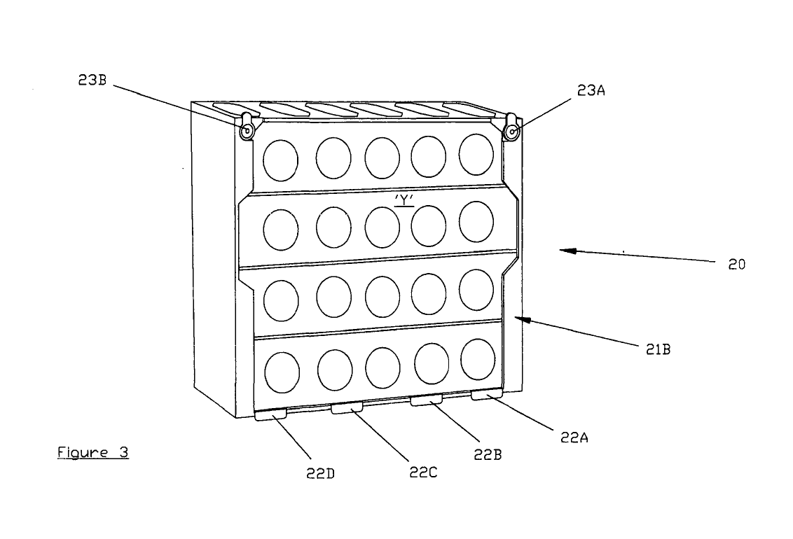

FIG. 3 shows rear view of a wall component,

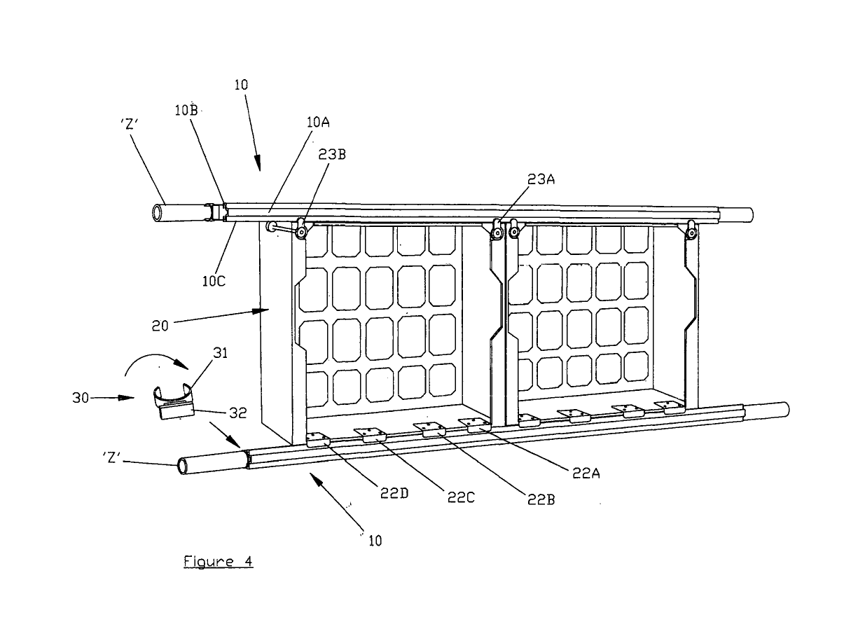

FIG. 4 shows a view of the rear of two wall components connected to the track and irrigation clips,

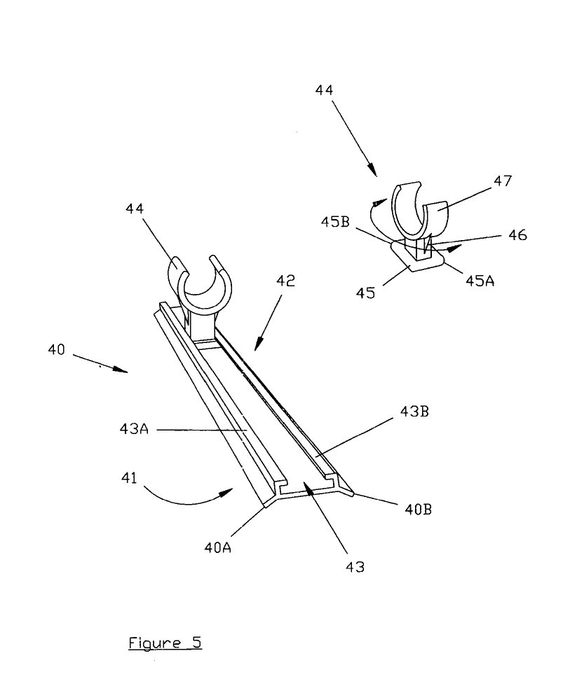

FIG. 5 shows a perspective view of a cover plate, and

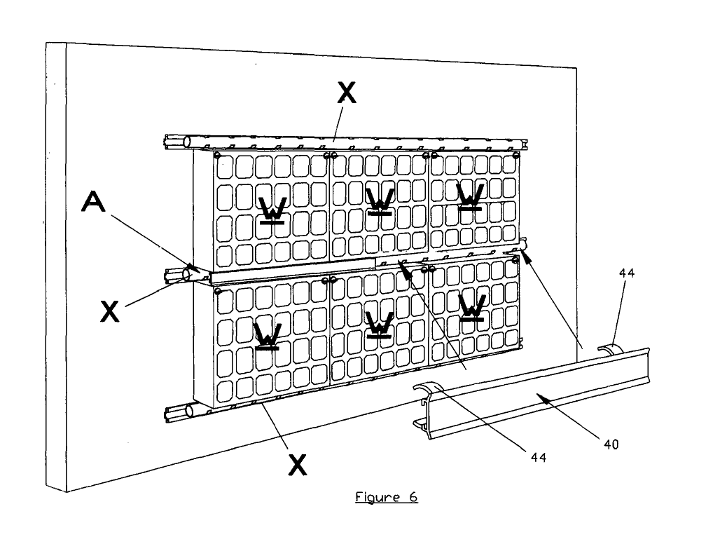

FIG. 6 shows a view of a wall system with cover plates

Referring to FIGS. 1 and 4 there is shown part of a wall component and track system 1 for growing plants.

A plurality of tracks 10 are provided for securement horizontally against a wall 2 at spaced intervals. Three tracks 10 are shown but many more may be provided. Each track is generally T-shaped with a stalk 10A for securement to wall 2, and arms 10B,10C spaced from the wall 2 by its stalk. Each stalk 10A may be secured to the wall 2 by screws W or other fixings. The arms of each track form a C-shaped channel 10D.

The track may conveniently be formed as an extrusion e.g. of plastics or aluminium.

A plurality of identical wall rectangular box components 20 are adapted to be placed between adjacent tracks. As shown in FIG. 2, components 20 each have a front vertical (in use) face 21A with a plurality of apertures X to receive plants. As shown in FIG. 3, components 20 will in use be filled with a growing medium such as Grodan Y (trade mark). As shown in FIG. 3, each component has upper and lower engagement members to releasably engage with a track above and below a component. The lower engagement member is in the form of four projecting static lugs 22A,22B,22C,22D which engage between an arm of a track and the wall to which the track is mounted (see FIG. 4). Lugs 22A,22B,22C,22D project downwards from the back face 21B of the component 20. The upper engagement member is in the form of a pair of fingers 23A,23B which rotate from a first non-projecting position to a second projecting position (as shown in FIGS. 3 and 4).

Fingers 23A,23B project upwards from the back face 21B of the component 20, but are rotated by heads 24A,24B on the front face 21A of the component. Fingers 23A,23B also engage between an arm of a track and the wall to which the track is mounted (see FIG. 4). A friction device may be used to releasably retain a finger in a first or second position.

Securement means in the form of pipe clips 30 are provided to secure irrigation pipes Z to the tracks in vertical spaces between horizontal rows of wall components 20. Each clip 30 has a C-shaped body 31 to engage a pipe, and a lug 32 which engages with the C-shaped channel when clip twisted.

In use of the system rows of tracks 10 are secured to a wall by screws W, with each adjacent tracks 10 spaced apart by the height of a component 20. Clips 30 are placed in the C-shaped channels and irrigation pipes Z placed in the clips. Components are then placed and secured in the tracks by placing the lower static lugs 22A,22B,22C,22D between an arm 10B and the wall 2, and then rotating the fingers 23A,23B using heads 24A,24B so that the fingers 23A,23B engage between an arm 10C and the wall 2.

If it is desired, components 20 can easily be removed from the tracks 10 by rotating heads 24A,24B to rotate the fingers so that they do not project from a component, and simply removing the panel. The irrigation pipes can be easily remove by unclipping them form the clips 30.

When creating the wall, the components can be secured to the tracks at one end of the tracks, and pushed to slide horizontally along the track to a desired position. This means the wall can be created by a person at one end of the track so obviating the need to erect scaffolding up when first erecting the wall.

If desired the irrigation could be formed without using the securement means such as clips 30. Also the securement means and clips could be used with components and tracks where the components do not releasable engage with the track.

Referring to FIG. 5 there is shown an elongate cover plate 40 with a front face 41 and rear face 42. Cover plate 40 may be extruded from plastics and may have angled edges 40A,40B to add rigidity to its structure.

Rear face 42 forms a C-shaped channel 43 formed by opposing L-shaped projections 43A,43B. Channel 43 takes engagement means in the form of clips 44.

Clips 44 have a rectangular base 45 with radiused corners 45A,45B. Connected to the base is a stalk 46 supporting a deformable C-shaped gripper 47 to engage over an irrigation pipe X (see FIG. 6).

Clips 14 can be releasably positioned at any point along the plate 10 by inserting each clip base 15 into a channel 13 and rotating it through 90 degrees whereby it locks at a desired position along the channel 13.

Referring now to FIG. 6, there is shown a wall system in which a plurality of wall components W (such as shown in FIG. 1) are arranged in rows and columns with vertical spacing A between rows of components. Irrigation pipes X are provided and secured in the in the space between rows of components to irrigate the wall components.

Cover plates 40 as shown in FIG. 1 can be secured in the spacing between rows of components by clipping grippers 47 of clips 44 onto the irrigation pipes X. The cover plates 40 hide the irrigation pipes X and the space A between rows of components. The clips 44 are positionable at different locations on the rear face to avoid any fixings on the irrigation pipe.

It is envisaged that cover plates 40 would be formed in one or more lengths, e.g. 1.2 m and 2.4 m lengths and two or more can be abutted end to end to make a long cover.

The cover plates 40 are shown in use with the system described in FIGS. 1 to 4, but could be used in other systems to hide irrigation pipes.

The invention may take a form different to that specifically described above.

Further modifications will be apparent to those skilled in the art without departing from the scope of the present invention.

1-29. (canceled)

30. A wall component and track system for forming a wall for growing plants comprising:
a plurality of tracks; and
a plurality of wall components,
wherein at least a portion of said tracks are secured against a wall at vertically spaced intervals; said wall components configured to include at least one upper engagement member and at least one lower engagement member; said upper engagement member configured to releasably engage at least one track positioned above said wall component; said lower engagement member configured to releasably engage at least one track below said wall component; and said wall component comprising at least one aperture configured to receive at least one plant.

31. The wall component and track system of claim 30, wherein said upper and lower engagement members comprise lugs and rotatable fingers, and said lugs and rotatable fingers are configured to engage with said tracks.

32. The wall component and track system of claim 31, wherein said wall components comprise a front face and a back face, said lugs and rotatable fingers project adjacent to the back face of each said wall component, and said rotatable fingers are configured to be rotated from said front face.

33. The wall component and track system of claim 32, wherein at least one track comprises a stalk configured to secure said wall component to said wall and at least two arms protruding from said stalk, and said lugs and said rotatable fingers attached to said wall component are configured to fit between said wall and said track arms.

34. The wall component and track system of claim 33, wherein said track is T-shaped.

35. The wall component and track system of claim 33, wherein said track arms form a channel configured to fit at least one pipe support, said pipe support comprises clips, and said dips comprise lugs configured to engage with the channel when said clips are rotated.

36. The wail component and track system of claim 30, further comprising at least one cover plate, wherein said cover plate comprises a front face and a back face, said cover plate placed between said wall components to conceal a space between said components, said back face supporting at least one clip configured to secure said cover plate between said wall components.

37. The wall component and track system of claim 36, wherein said space comprises at least one pipe, said channel configured to hold said pipe, and said cover plate configured to conceal said pipe.

38. The wall component and track system of claim 37, wherein said pipe is an irrigation pipe.

39. The wall component and track system of claim 37, Wherein the channel is U-shaped.

40. A wall mounted growing system comprising:
a plurality of tracks; and
a plurality of wall components,
wherein said tracks are secured horizontally against a wall at vertically spaced intervals with a first track secured adjacent to at least a second track, said wall components configured to he placed between rows of adjacent tracks, said wall components configured to releasably connect with said tracks, said tracks configured to releasably connect to at least a portion of a pipe, said wall components configured to releasably connect to at least a portion of said pipe, and said wall components comprise at least one aperture configured to receive at least one plant.

41. The wall mounted growing system of claim 40, wherein said tracks comprise a U-shaped channel configured to hold pipe supports, said pipe supports comprise at least one clip, and said clips comprise lugs configured to connect with the U-shape channel when the clips are rotated.

42. The wall mounted growing system of claim 40, wherein at least one cover plate is placed between said wall components and configured to hide said pipe.

43. The wall mounted growing system of claim 42, wherein said cover plate comprises a front face and a back face, said back face configured to hold at least one clip, said clip configured to fit over said pipe, and said clip configured to secure said cover plate to at least one adjacent wall component.

44. The wall mounted growing system of claim 43, wherein said clip is configured to connect to said back face at different locations, said back face forming a C-shaped channel configured to hold at least one clip, said clip including lugs releasably connected to said C-shape channel when said clip is rotated, and said pipe is an irrigation pipe.

45. A method for mounting a wall system comprising the steps of:
securing at least one trade to a wall;
releasably securing at least one wall component to said track;
configuring said wall component to hold an aperture;
configuring said aperture to hold at least one plant;
configuring said track to connect to at least one pipe;
connecting said pipe to said wall component; and
releasably securing a cover plate over said pipe.

46. The method of claim 45, wherein there is at least one space between at least two adjacent wall components, further comprising releasably securing a cover plate over said space, and configuring said cover plate to conceal said pipe.

47. The method of claim 45, wherein at least two tracks and two wall components are secured to the vertical structure, further comprising the step of releasably connecting at least a first wall component with at least a second adjacent wall component.

48. The method of claim 45, wherein said pipe is an irrigation pipe.

49. The method of claim 45, further comprising the step of using at least one clip to releasably secure said pipe to said track, and using at least one clip to releasably secure said pipe to said cover plate.
